(19) United States
(12) Patent Application Publication
(10) Pub. No.: US 2010/0112276 A1
(43) Pub. Date: May 6, 2010

(54) Multiple Weak Cross-Linking of Carbon Nanotubes for Fiber Reinforcement

(76) Inventors: Evgueni Vladimir Tsiper, Alexandria, VA (US); Noam Bernstein, Alexandria, VA (US); Mark Roger Pederson, Washington, DC (US)

Correspondence Address: Evgueni V. Tsiper, Ph.D, 3678 Birchpond Pl., Saint Paul, MN, 55122, US

(21) Appl. No.: 11/456,557

(22) Filed: Jul. 10, 2006

Related U.S. Application Data
(60) Provisional application No. 60/697,380, filed on Jul. 8, 2005.

(51) Int. Cl. B32B 5/12

(52) U.S. Cl. 428/114; 977/742; 977/750

(57) ABSTRACT

A composite material comprises a multitude of carbon nanotubes, where the majority of the carbon nanotubes have an aspect ratio of at least 25, and are connected to at least one other carbon nanotube using a multitude of weak links. The multitude of weak links provide tensile strengths similar to that of covalent links, utilizing high aspect ratio and high strength of individual carbon nanotubes. Weak links include hydrogen bonds, metallocene bonds, ionic bonds and/or electrostatic forces. One or more metal ions, such as chromium ion, are used to create the metallocene bonds directly between two carbon nanotubes. One or more carbon nanotubes may be functionalized with one or more side chain groups.

### CROSS REFERENCE TO RELATED APPLICATIONS

The present application claims the benefit of provisional patent application Ser. No. 60/697,380 to Tsiper et al., filed on Jul. 8, 2005, entitled “Multiple Weak Cross-linking of Carbon Nanotubes for Fiber Reinforcement,” which is hereby incorporated by reference.

### BRIEF DESCRIPTION OF THE DRAWINGS

FIG. 1 shows an example of a diagram of cross-linking carbon nanotubes with multiple weak bonds.

FIG. 2 shows another example of a diagram of cross-linking carbon nanotubes with multiple weak bonds.

FIG. 3 shows an example of a diagram of cross-linking carbon nanotubes with multiple hydrogen bonds.

FIG. 4 shows an example of a diagram of cross-linking carbon nanotubes with multiple hydrogen bonds between biological functional groups.

FIG. 5 shows an example a diagram of structure of a metallocene bond formed between nanotubes involving a chromium ion.

FIG. 6 shows an example a diagram of a chromium ion being added to a SWNT or MWNT to form a metallocene bond.

FIG. 7 shows an example a diagram of the resulting force preventing sliding when a chromium ion links to carbon nanotubes.

FIG. 8 shows another example a diagram of the resulting force preventing sliding when a chromium ion links to a carbon nanotubes.

### DETAILED DESCRIPTION OF THE INVENTION

The present invention relates to methods of cross-linking carbon nanotubes (“CNTs”) noncovalently for increasing the tensile strength of CNT fibers without significantly damaging the mechanical properties of individual CNTs. CNTs herein encompass both single-wall nanotube (“SWNT”) and multi-wall nanotube (“MWNT”) configurations.

In particular, the invention relates to establishing a multitude of weak links between substantially parallel CNTs. These weak links tend to work not only mechanically in accord, but also as well as a single strong (covalent) link. Using multiple weak links may utilize extended dimensions and exceptional strengths of individual CNTs. Also, using multiple weak links may result in an increase in the mechanical properties of fibers comprising CNTs.

Embodied is a composite material comprising of a multitude of carbon nanotubes, where the majority of the carbon nanotubes have an aspect ratio of at least 25, and are connected to at least one other carbon nanotube using a multitude of weak links. The process of binding CNTs by creating a multitude of weak links between at least two CNTs.

Each CNT may be elongated with a cross-section diameter of less than 40 nm, have a tensile strength of at least 0.1 GPa (“Giga-Pascals”), and having a length of at least 0.1 μm.

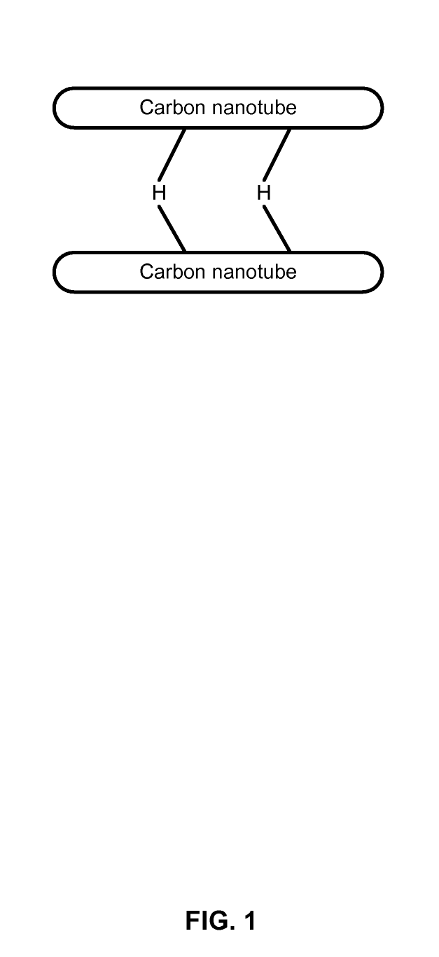

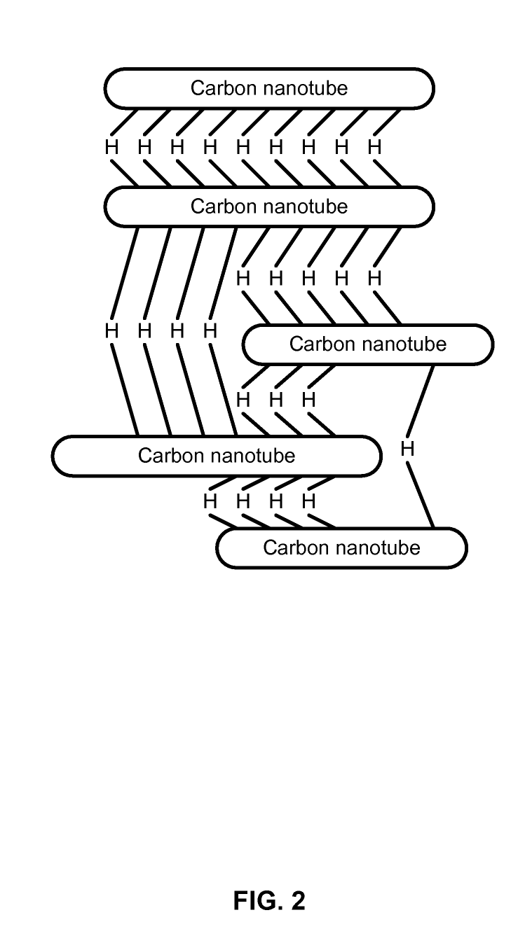

FIG. 1 shows an example of the composite material. However, the composite material is not limited to just one CNT being connected to at least one other CNT. As shown in FIG. 2, the composite material may also comprise a plurality of CNTs. Each CNT of the plurality may have the same configuration as a single CNT above. Moreover, each CNT of the plurality may be connected to at least one CNT using multiple weak links.

The cross-section diameter is measured from the median portion of the CNT. Structurally, each CNT can be composed mainly of carbon. Alternatively, instead of carbon, the nanotube may be composed mainly of silicon or phosphorous.

The aspect ratio is defined to be the length of the CNT divided by the cross-section diameter.

The key to creating the composite material is using multiple weak links to bind two or more CNTs. Weak links are defined to be any type of link (such as a chemical bond) other than a covalent link (such as a covalent bond). For instance, weak links include, but are not limited to, hydrogen bonds, metallocene bonds, ionic bonds, van der Waals (“vdW”) forces, electrostatic forces, magnetic forces, etc. The weakness of these links can be overcome by implementing a multitude of weak links, utilizing extended dimension(s) of individual CNTs and the tensile strengths of individual CNTs.

It is generally known that CNTs tend to stick together in bundles. However, they retain the ability to slide along the bundles, which may adversely affect the tensile strength of fibers made of CNTs. The purpose of using multiple weak links is to attach or glue CNTs together and prevent attached CNTs from sliding. This notion is contrary to the currently known exploration of using noncovalent linkage for dispersing CNTs. See, e.g., Tasis, Dimitrios, et al., Chemistry of Carbon Nanotubes, 106 Chem. Rev. 1105-1136 (2006).

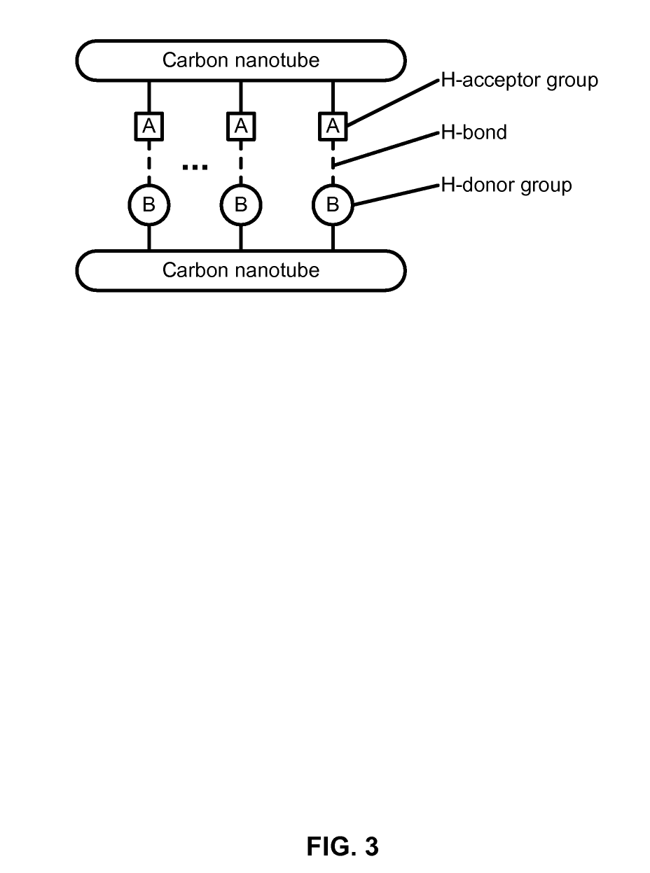

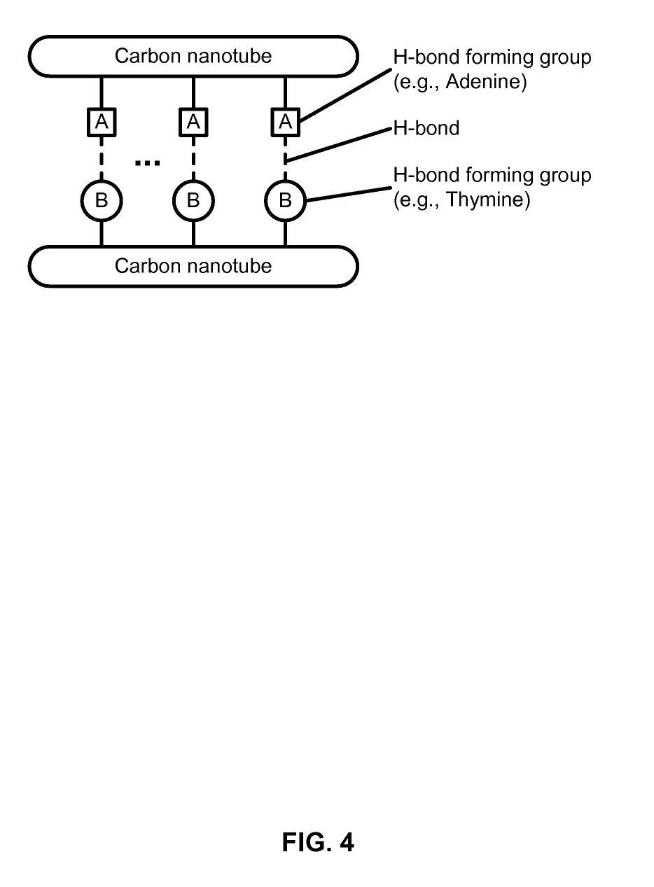

In one embodiment, as shown in FIGS. 1 and 2, multiple hydrogen bonds are used as the multiple weak links. To create hydrogen bonds, each CNT may be functionalized with one or more side chain groups, such as hydrogen bond forming groups. As shown in FIGS. 3 and 4, the hydrogen bond forming group may be a hydrogen acceptor group or a hydrogen donor group. Where a hydrogen acceptor group is functionalized to a CNT, the hydrogen bond is likely to be formed with its opposite, a hydrogen donor group that is functionalized to another CNT. Similarly, where a hydrogen donor group is functionalized to a CNT, the hydrogen bond is likely to be formed with its opposite, a hydrogen acceptor group that is functionalized to another CNT.

The length of the hydrogen bond tends to be approximately 2 Å (or about 0.2 nm). This length is slightly longer than a covalent bond, which is approximately 1-1.5 Å. The hydrogen bond tends to break if it is stretched to a distance of approximately 1 Å.

The hydrogen bond may have only 5% of so of the strength of a covalent bond. However, when multiple hydrogen bonds can be formed between two CNTs (or e.g., molecules or parts of a molecule), the resulting union can be sufficiently strong. The cumulative effect of multiple hydrogen bonds arranged in such a way can contribute to the stability and structural rigidity and integrity, exploiting the large aspect ratio and strength of individual CNTs.

To exemplify this model, the nucleotides of deoxyribonucleic acid (“DNA”) and ribonucleic acid (“RNA”) may be considered. Thymine and uracil generally form hydrogen bonds with adenine. Similarly, cytosine generally forms hydrogen bonds with guanine. Each of these nucleotides may be functionalized to a CNT.

As an alternative to CNT functionalization with nucleic acids, each CNT may be functionalized with one or more different side chains, capable of forming weak links. Each side chain may be as a long as a few nm. Various examples of side chains include, but are not limited to, alcohols, aldehydes, alkali metals, alkaline earth metals, alkyls, amides, amines, aromatic compounds (e.g., phenols, etc.), aryls, esters, ethers, carboxylic acids, halogens, hydrogen, ketones, metalloids, nitriles, nonmetals, poor metals, sulfides, thiols, transition metals, etc. Procedures for attaching side chains onto CNTs are generally known in the art. See, e.g., Tasis.

A side chain group functionalized with a first CNT may form a weak link to a second CNT. Yet, the weak link here may be any other weak link described above. As one embodiment, a specific weak link is a metallocene bond, where the bond is created between a metal ion and two or more CNTs. Nonlimiting examples of metal ions include chromium, iron, nickel, lead, zinc, etc. The side chain group that is functionalized with the first CNT may even form weak links with one or more side chain groups that is/are functionalized with the second CNT. It is possible that the majority (e.g., >50%) of the side chain group is the same.

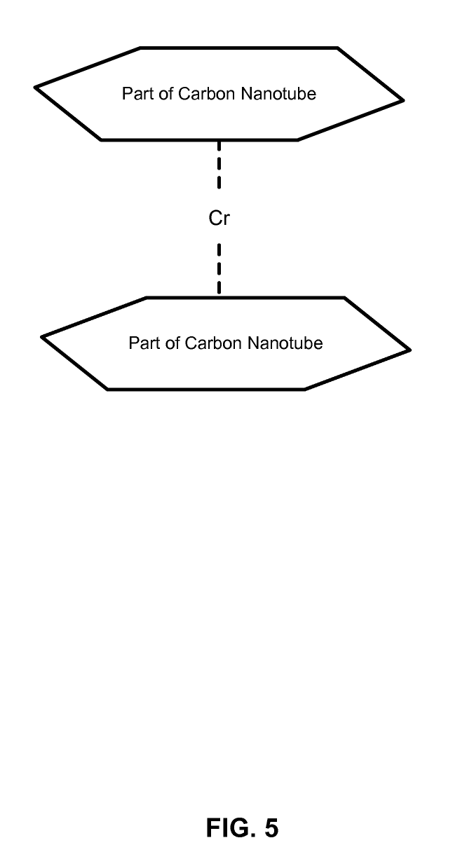

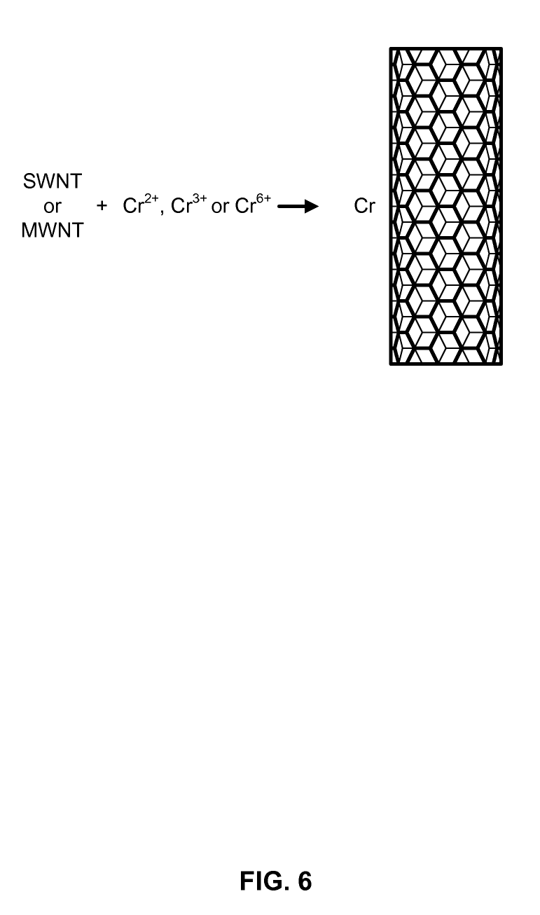

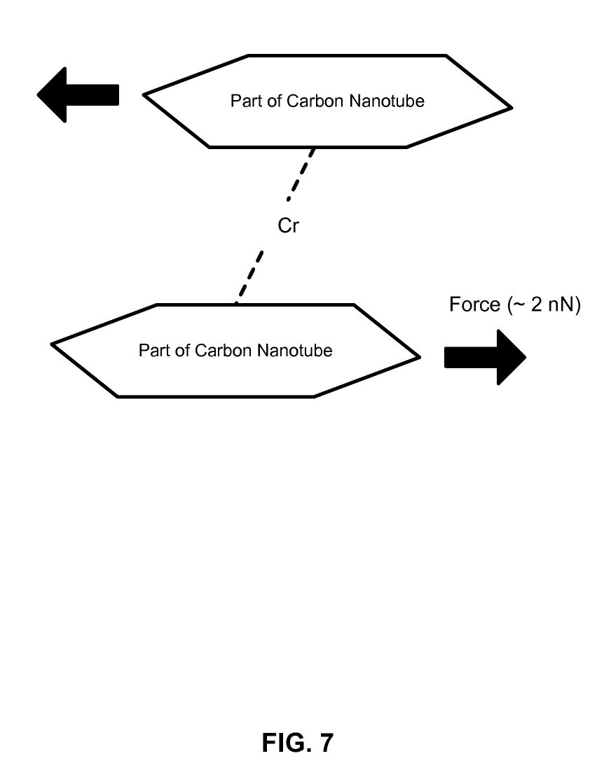

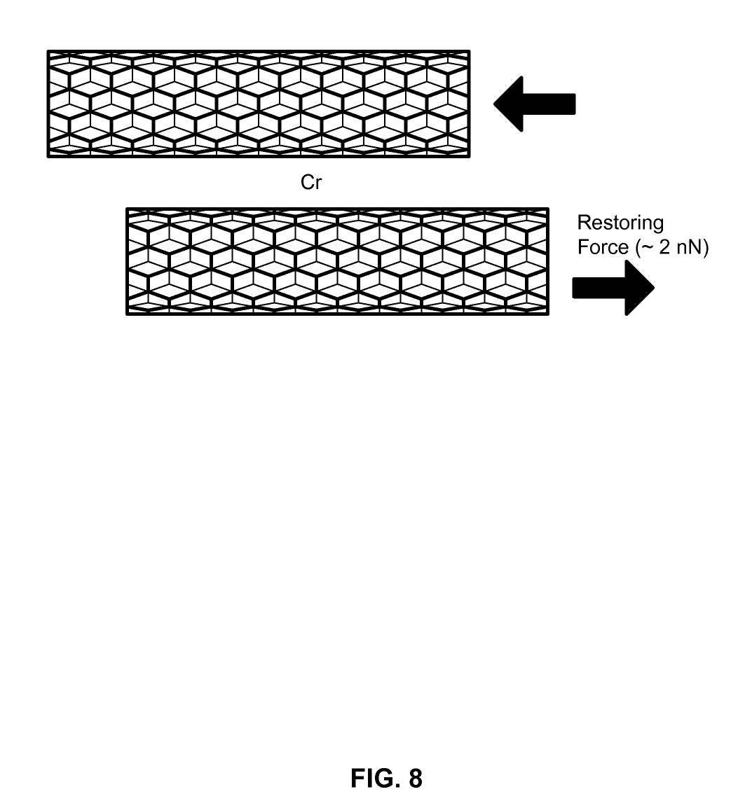

A purpose of using metallocene bonds is to prevent the sliding effect of CNTs. In one embodiment, a chromium ion is used to create a metallocene bond directly between two CNTs. As shown in FIGS. 5 and 6, when chromium ions are intercalated with a SWNT or MWNT, metallocene bonds may be formed. As a result, a restoring force along the bundle between chromium and the CNT, and therefore, between two CNTs. As indicated in FIGS. 7 and 8, the restoring force may reach at approximately 2 nN (nanoNewtons), which may hinder sliding.

As another embodiment, the side chain group of a first CNT may be different from, yet capable of using weak links to bind with, the side chain group of a second CNT. For example, differing nucleic acids functionalized on different CNTs may be linked together by hydrogen bonding (e.g., adenine-thymine, cytosine-guanine, adenine-uracil, etc.).

I. Carbon Nanotubes

CNTs have exceptional strength due to the underlying structure of the graphene sheet.

Typically, the graphene sheet displays some of the strongest carbon-carbon (“C—C”) bonds in nature. Arguably, these bonds are stronger even than C—C bonds in diamond.

Yet, neighboring sheets that make graphite layers (or the neighboring CNTs in a bundle) are usually held together only by vdW forces, allowing the sheets to easily slide against each other. Thus essentially, this effect makes graphite slippery, thus making them favorable as lubricants.

The Young's modulus of an individual CNT is exceptionally high, close to 1 TPa, while the shear modulus of a CNT bundle has been measured about 1 GPa, which is nearly that of graphite. Nanotube fibers that are tens of cm long and nanotube composite fibers up to 100 m can be produced. Typically, these exhibit a Young's modulus of about 10 GPa to about 20 GPa (for macroscopic mechanical measurements) and generally not more than 80 GPa (for microscopic (atomic force microscopy (“AFM”)) measurements). These measurements are generally far below that of an individual CNT strength. CNT fibers typically break at tensile loads of about 100-200 MPa, although values of tensile strength can reach up to about 1.8 GPa. Thus, the strength of individual nanotubes does not translate into macroscopic properties of CNT-based materials unless there is a controllable way to cross-link the CNTs to prevent them from sliding against each other.

II. CNT Cross-Linking

Efficient cross-linking continues to be a theoretical and experimental object of intense studies. One available tool to induce changes in CNT-based macroscopic materials is irradiation with either electrons or ions. This irradiation is generally known to have profound effects on nanotube and fullerene structures. On one hand, irradiation can be employed to induce desired structural changes. On the other hand, it may cause unwanted deterioration of structure, such as amorphization. Recent observations have shown that moderate 80-keV electron beam irradiation may cause a 30-fold increase in the bending modulus of SWNT bundles (AFM measured). However, harder or higher doses of irradiation may lead to degradation of structure and mechanical properties.

The sp²-hybridized C—C bonds in the graphene sheet prefer planarity as the most energetically-stable configuration. Narrow SWNTs tend to have C—C bonds strongly strained, which often increases chemical reactivity. This reactivity, which may be enhanced even more at the fullerene caps, may be used as a basis for linking CNTs end-to-end. Potential spontaneous cross-linking of narrow-diameter CNTs into two dimensional structures may be predicted based on density functional theory (“DFT”) calculations.

Irradiation-induced SWNT coalescence may lead to cross-linking between CNTs touching at an angle. However, a fundamental problem seems to exist. Parallel CNTs, as in fibers, tend to exhibit circumference doubling (e.g., merging) instead of cross-linking. Such merging appears consistent with the preference to reduce curvature.

Another potential problem involves the significant change in the chemical structure of CNTs near the link area, which may degrade the underlying mechanical properties of individual CNTs. Covalent cross-linking by irradiation-induced coalescence may affect the whole CNT cross-section and along many lattice spacings. This effect appears to be reminiscent of the effect of diameter doubling.

III. Direct Linking

A. Covalent Linking

The fundamental reason for the strength and stiffness of CNTs is the nature of the C—C covalent bonds. Linking CNTs together by using such covalent bonds can possibly make the strongest possible cross-links. However, using covalent bonds for cross-linking is not topologically possible.

Attempts to cross-link CNTs directly through partial or complete fusing of the tube structures inevitably lead to highly strained regions with a large curvature that may compromise the mechanical properties or even the stability of the constituent CNTs. One alternative is to make a number of covalent bonds between intact molecules, directly or through organic molecules, that bridge the CNTs. These molecules can be engineered to maximize the strength of the molecule-CNT covalent bond. They can also be engineered to minimize the reduction in intra-CNT bonding.

For example, a calculation of the binding of two C₆₀ molecules by a pair of covalent bonds, forming a four-fold ring, shows that this configuration is stable. Since the binding energy of 0.3 eV is much lower than the intra-CNT bond strength of about 4 eV, this computation is unlikely to be a direct route for nanotube cross-linking

An approach that has the potential for higher performance and for more controllability is to functionalize the tube with organic molecules. The strength of one particular type of molecule has been calculated using DFT, albeit not in the context of cross-linking tubes. The results were strongly dependent on tube curvature, with the expected trend of stronger bonding to narrow (e.g., highly curved) tubes than to wider (e.g., less curved) tubes. For instance, the results for narrow tubes show binding energies of about 1.5 eV, a significant fraction of the intra-tube C—C bond. Such a high binding energy indicates that is a promising approach, at least for narrow CNTs. Systematically, the binding of different molecules to the CNT may be studied to develop an understanding of the bonding. Besides focusing on the strength of the CNT-molecule bond and the intra-molecule bond, other factors to consider include limitations to overall strength, details of the molecule beyond the radical that binds to the CNT and on the CNT helicity, and the limit on achievable density of cross-links (e.g., per tube unit length).

Another atomic species that can bind to fullerenes and CNTs is sulfur. While the most common interaction is vdW binding of S₈ rings to a C₆₀ molecule, there is also some experimental and theoretical evidence of covalent bonding between the sulfur and carbon atoms. Results using semi-empirical methods suggest that quite strong bonds, which are comparable to carbon-fullerene or carbon-CNT bonds, are possible.

One important factor that limits the strength of covalent bonds to the CNT's carbon atoms is the need to break some of the it bonds within the CNT. The presence of Stone-Wales defects that consist of a pair of five-fold and a pair of seven-fold rings may disrupt the π-bonding locally and facilitate bonding between the CNT and a functional group. Such defects can be introduced mechanically and may be the predicted mechanism for plastic deformation in CNTs.

Covalent CNT cross-linking, with either direct C—C bonds or through functional groups attached to CNT sidewalls or endcaps, has an obvious advantage of strength that covalent bonds provide. However, it also has several disadvantages. For instance, any significant change in the chemical structure of CNTs near the link area may degrade the underlying mechanical properties of individual CNTs. Also, irradiation-induced cross-linking may affect the CNT integrity and reduce mechanical strength. Additionally, the energetic stability of the perfect graphene sheet tends to reduce curvature. This reduction may lead to diameter doubling instead of cross-linking. Even more, it is unlikely that a method is known to controllably establish covalent cross-links between CNTs with functional groups. Plus, making ceramic CNT-containing composites may require high-temperature processing. Yet, the functional groups are known to disattach at heating. Eventually, the energetically-stable nanotube structure would be restored.

B. Metallocene Linking

A completely different type of bonding can occur between metals and CNTs. In one embodiment, as shown in FIGS. 5-8, weak links are realized in the form of metallocene bonds involving transition metal ions. It is well known in the art that various metals (e.g., chromium, iron, nickel, etc.) can bond two benzene (C₆H₆) or cyclopentadienyl (C₅H₅) rings to form metallocene sandwich compounds. Complexes involving these metals and other related metals have also been shown to bind to C₆₀ and to CNTs. For example, Cr has been suggested as a route for bonding C₆₀ molecules in a crystal.

The type of metal that strongly bonds two C rings may depend on the ring sizes. For example, while Cr tends to strongly bond to two six-fold rings, other metals may directly bond to rings of different diameters. In general, counting one electron contribution from each C atom and all of the valence electrons of the metal, combinations that satisfy the “18-electron rule” may form a strong bond. This combination means that metals with less potential for toxicity (such as Ti, Zr, Fe or Ni) can be used to bond CNTs at five-fold or seven-fold ring sites. As previously mentioned, such ring configurations can be engineered into the CNT by mechanical loading. The presence of metal atoms may even be a route to creating such rings in a controlled manner. Additionally, the sensitivity of metallocene bonding strength to carbon ring size can be used to affect the creation of five-fold or seven-fold rings by controlling concentrations of metal ion in the process of nanotube formation.

While most synthesis routes for creating conventional metallocene compounds tend to be in the gas phase, this approach may be impractical to apply to a CNT fiber, sheet, or composite. Yet still, metallocene cross-linking (such as bonding the CNTs through metal centers) may be achieved in steps. For example, one step is binding at least two CNTs:

C₆H₆MC₆H₆+CNT→C₆H₆MCNT+C₆H₆ (1).

Since a single metal atom may require the two adjacent rings to be in close proximity, the geometry of the two tubes to be linked is important. In chiral tubes, not every ring site on one tube will necessarily line up with a relevant site on another tube. Therefore, non-helical CNTs are favorable. However, helical CNTs may also benefit from metallocene bonding.

C. Other Chemical Group Linking

Functionalization of CNTs with chemical groups capable of forming hydrogen bonds may increase their interactions with solvents to improve solubility. The hydrogen bonds may even be used as a process step to achieve covelent bonding in the construction of nanotube matrix materials. Such groups can be attached to the sidewall of a CNT by a variety of known techniques. For example, the surfaces of carbon-containing materials can be modified by electrochemical reduction of diazonium salts. Such process is used to derivatize CNTs with a selected functional group.

Additionally, SWNTs having substituents attached to the side wall of the nanotube may be prepared by reacting the CNTs with fluorine gas. The fluorine derivatized carbon-nanotubes may be recovered and reacted with a nucleophile. Furthermore, arrays of such derivatized CNTs for the purpose of making CNT fibers may also be assembled.

IV. Cross-Linking by Polarization Forces

CNTs may be non-covalently cross-linked using non-covalent polarization interactions, such as hydrogen bonding. Hydrogen bonds are weak. They are mostly polar interactions that are typically established between neighboring chemical groups with closed shells. One of the groups contains a hydrogen and is called a “hydrogen donor.” The other group, a “hydrogen acceptor,” contains an electronegative atom, such as oxygen or nitrogen with one or more lone pairs. The hydrogen bond is formed when a bridging hydrogen is oriented towards the lone pair of the hydrogen acceptor.

The relative weakness of hydrogen bonds can be compensated by a multitude of links per unit CNT length. This multitude can take advantage of the exceptional strength of individual SWNTs. Specifically, individual nanotubes can be functionalized with appropriate polar groups, which are able to interact and form hydrogen bonds when the nanotubes are brought in contact. For example, as one embodiment, sidewalls of individual CNTs may be used to achieve this advantage. Orientation dependence of hydrogen bonds may even provide a mechanism for self-aligning the individual nanotubes. The alignment may be achieved by means of stretching or hydrodynamic flow effects.

Hydrogen bonds have binding energies with a factor of about 40 to about 80 less than that of covalent bonds. This factor is why they are usually discarded from consideration when the mechanical strength is desired. However, because of the superior strength of individual nanotubes, several weak links between two individual CNTs may perform just as well as a single covalent cross-link. A typical hydrogen bond, like that in water, can sustain a force of 0.25 nN (nano-Newtons) when stretched ˜1 Å. In comparison, a breakdown tensile strain of about 0.15 GPa for nanotube fibers made of SWNT packed in hexagonal lattice with α=17Å may translate into about 0.375 nN force exerted on a single nanotube. Thus, it is likely that only several hydrogen bonds per nanotube will affect mechanical properties of the fiber.

A. Advantages

Non-covalent cross-linking provides an array of advantages.

This approach may separate inter-CNT and intra-CNT challenges and split a single problem into two separate technological steps. One step is functionalization of individual CNTs. Functionalization deals with individual CNTs and can be made more controllable with chemical methods. Another step is the assembly of a macroscopic material from previously functionalized blocks. Specific designs of one or more functional groups can transform the assembly step into self-organization or self-assembly. Each step may benefit from a broader array of tools than those available for inducing chemical transformations in a macroscopic material.

Functionalization of CNTs can also allow for lesser damage to the CNT structure than nanotube coalescence. Thus, mechanical properties of individual CNTs are better preserved. For example, a functional group can be attached to a single carbon atom, leaving the circumference of the nanotube nearly intact.

In addition, high temperature treatment, which is a major obstacle against sidewall functionalization, can be avoided. Functional groups are known to disattach at heating, such as in ceramic processing. Such disattachment may allow for the restoring of the energetically-stable nanotube structure.

Another advantage pertains to the hydrogen bonds. Since individual hydrogen bonds are weak, their breakdown under mechanical stress will not likely cause damage to the CNT chemical structure. Thus, the breakdown of the macroscopic material can be reversible. Reversibility of breakdown of weak links can provide fibers with unique mechanical properties of withstanding irreversible stretching. It is even possible for a macroscopic fiber to stretch under severe load, but still preserve its mechanical properties in the stretched form.

Furthermore, individual hydrogen bonds tend to have binding energies of only several kT at room temperature. Hence, mild temperature conditions can be used in the technologic process to control binding and unbinding (e.g., denaturation).

Moreover, another advantage concerns polarity. The strength of polarization interactions can be controlled by the dielectric properties or pH of the solvent. It may be possible to switch the interactions on and off during the technological process.

Polarity of the individual functional groups intended to form hydrogen bonds can be exploited at the functionalization step. For example, periodicity of the groups attaching to a single CNT can be enforced by the repulsive forces between the groups of the same kind Also, the polarity of certain functional groups can be employed for establishing patterned attachments of functional groups, as opposed to random attachments when not guided. Patterned attachment may provide better inter-CNT bindings with fewer functional groups.

Two types of polar groups necessary to achieve hydrogen bonding may allow one to create two types of CNTs such that the CNTs of each group will not bind to themselves, but rather only to CNTs of the other group. Such binding suggests a broad range of technological advantages that can exploit two-component processing that is similar, but not identical, to epoxy glues.

B. Computational Base

Unlike covalent bonding, computer modeling of polarization interactions tends to be more difficult with standard DFT techniques. One reason is that smaller energy scales are involved. Another reason is that Coulomb forces are long ranged. These challenges can be overcome by combining atom-atom polarizabilities with minimal atomic multiple expansion (“MAME”).

Reproducing energetics of non-covalent polarization interactions may require molecular electrostatic potentials to be accurate everywhere beyond the molecular volume. MAME charges are designed for this purpose. They are based on DFT-quality single-molecule electrostatic potential φ(r) and minimize the least-square error:

σ²=S⁻¹∫∘_{S}dS[φ_{MAME}(r)−φ(r)]² (2)

over an iso-density surface S, which defines molecular volume. φ_{MAME}(r) is the potential produced by the minimal set of atomic multipoles and is accurate beyond S by virtue of the Laplace equation Δφ=4πρ≈0.

This combination of MAME atomic multipoles with distributed polarizabilities tends to yield very accurate description of polarization forces in water, include hydrogen bonding. The accuracy is comparable to the best available parameterizations for the water pair potentials, such as VRT(ASP-W)III and SAPT-5s. Additionally, distributed polarizabilities consistent with MAME scheme tend to give better vdW energies. It is expected that non-covalent cross-linking is instrumental by allowing computation of inter molecular forces between nanotubes functionalized with polar groups.

Polarization interactions between large it-conjugated molecules often require careful treatment of intramolecular charge redistribution. Atom-atom polarizabilities have been successfully used to describe charge redistribution in polarization in various organic molecular systems, including organic thin films. Very large clusters up to 10⁴ molecules in arbitrary geometry can be studied. All molecules in the cluster may be treated rigorously as quantum objects subject to self-consistent fields of each other.

The key quantity that governs intramolecular charge redistribution is the atom-atom polarizability tensor Πᵢⱼ and the associated polarizability:

$${\prod }_{ij} = - \frac{\partial {ρ}_{i}}{\partial {φ}_{j}} = - \frac{{\partial }^{2} E}{\partial {φ}_{i} \partial {φ}_{j}} \\ {α}_{α β}^{C} = {\sum }_{ij} {x}_{i}^{α} {\prod }_{ij} {x}_{j}^{β} \qquad ( 3 )$$

Here, E is the ground state energy of an isolated molecule in an external field. φⱼ=φ(rⱼ) is the “site potential” for an atom j, introduced into the calculation as a shift of the atomic orbitals that belong to the atom j. ρᵢ are the atomic charges.

The atomic charges are defined either as occupation numbers for orthogonalized atomic orbitals (Löwdin charges) or, more recently, using MAME scheme. Charge redistribution in a molecule is given by:

$${ρ}_{i} = {ρ}_{i}^{( 0 )} - {\sum }_{j} {\prod }_{ij} {φ}_{j} \\ {μ}_{i} = - \tilde{α} \cdot ∇ {φ}_{i} \qquad ( 4 )$$

where ρᵢ⁽⁰⁾ are the gas-phase atomic charges and μᵢ are induced atomic dipoles.

The large size of accessible clusters may allow one to treat solvent molecules explicitly beyond the usual cavity-based self-consistent reaction field (“SCRF”). An accurate description of salvation effects may be critical to polarization interactions, which are sensitive to the microscopic dielectric properties of the solvent.

Linearization of the quantum solution for a molecule in (nonuniform) external field of other molecules allows one to constrain quantum mechanics to the quantities Πᵢⱼ and \check{α}ᵢ, which are computed only once for each molecular species. Therefore, molecular dynamics for large clusters with intermolecular forces computed with this approach is feasible. Additionally, such molecular dynamics can be implemented by recomputing the self-consistent solution on-the-fly and be used to analyzed the dynamics of nanotube binding and dissociation.

C. Examples of Hydrogen-Bond Forming Polar Side Groups

Appropriate side groups may be chosen from a broad variety of polar groups capable of forming hydrogen bonds (e.g., such as amines, alcohols, ketones, esters, thiols or phenols). While sidewall functionalization of nanotubes is a growing field, functionalization with polar groups for hydrogen bonding does not seem to have drawn much attention. Functionalization of SWNTs with carboxylic acid groups has been recently reported; hydrogen bonds may be formed between such groups. Other side group examples can be borrowed from protein science, where protein secondary structure can be stabilized with hydrogen bonds formed between C═O and N—H groups of approaching peptide bonds. Functionalization with amide groups may induce hydrogen bonding between nanotubes of the same kind

In a particular example, CNTs of two types are functionalized separately with complementary hydrogen bond forming groups, such that same kind CNTs do not bind, but do bind to the opposite kind This functionalization may be achieved by functionalizing hydrogen donor groups (e.g., amines) with hydrogen acceptor groups (e.g. alcohols).

Another example includes nucleic bases (i.e., A (adenine), G (guanine), C (cytosine), and T (thymine)) forming selective strong complementary hydrogen bonded pairs AT and

CG, as in DNA and RNA structures. Thus, two-component compositions may be prepared, which can bind together upon mixing.

V. Simulation

Simulation of cross-linking nanotubes with non-covalent bonding has been achieved using the Vienna Ab-Initio Software Package (VASP) 4.6.21 software. DFT has been used, utilizing the Perdew-Burke-Enzerhoff (“PBE”) Generalized Gradient Approximation. Plane wave basis have been formed using projector-augmented waves pseudopotentials, carbon with 4 electrons in valence, and chromium with 6 electrons in valence shell. The energy cutoff was 500 eV.

The system studied included two 32-atom graphene sheets, 1 Cr atom, periodic boundary conditions, orthorhombic unit cell 9.867 Angstrom periodicity in plane and 12.33 Angstrom periodicity normal to planes.

The simulation has been performed with two parallel graphene sheets interlinked with a single metallocene bond involving a chromium (Cr⁶⁺) ion. The graphene sheets were set a fixed distance apart and allowed to relax in plane. The separation distance was optimized to minimize the total energy.

Two calculations were performed. One calculation was with two sheets aligned such that the Cr ion is in the most favorable position between two carbon rings. Another calculation was with one graphene sheet translated in-plane by one half of the unit cell so that the Cr ion is in an unfavorable position against a C—C bond.

The results show that the energy difference between the two configurations is 1.1 eV, or 1.76 e⁻¹⁸ Joules. Assuming the energy landscape is a cosine function with the amplitude 1.1 eV and the period of the graphene lattice, 2.529 Å (0.2529 nanometers), the maximum force that a single link can exert in the direction parallel to the graphene plane is:

$$F = \frac{1.1 eV}{2} * \frac{2 π}{2.529 Å} = 1.366 eV \text{/} Å = 2.189 nN .$$

In a typical CNT fiber, an area of cross-section that belongs to a single CNT is about S=250 Å² (Angstrom squared)=2.5 nm². Thus, the tensile strength of a CNT with a single link contributes about F/S=2.189 nN/2.5 nm²=0.88 GPa.

CNT fibers with tensile strengths of about 1.8 GPa have been reported. This is significantly below the theoretical maximum of tensile strength of 170 GPa. Typical reported values do not exceed 0.1-0.2 GPa.

Thus, if one were to divide 170 GPa by 1.8 GPa, it may take approximately 200 links per nanotube to max out the tensile strength of the bunch and bring it to the theoretical limit.

The foregoing descriptions of the embodiments of the invention have been presented for purposes of illustration and description. They are not intended to be exhaustive or be limiting to the precise forms disclosed, and obviously many modifications and variations are possible in light of the above teaching. The illustrated embodiments were chosen and described in order to best explain the principles of the invention and its practical application to thereby enable others skilled in the art to best utilize it in various embodiments and with various modifications as are suited to the particular use contemplated without departing from the spirit and scope of the invention. In fact, after reading the above description, it will be apparent to one skilled in the relevant art(s) how to implement the invention in alternative embodiments. Thus, the invention should not be limited by any of the above described example embodiments.

In addition, it should be understood that any figures, graphs, tables, examples, etc., which highlight the functionality and advantages of the invention, are presented for example purposes only. The architecture of the disclosed is sufficiently flexible and configurable, such that it may be utilized in ways other than that shown. For example, the steps listed in any flowchart may be reordered or only optionally used in some embodiments.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical invention of the application. The Abstract is not intended to be limiting as to the scope of the invention in any way.

Furthermore, it is the applicants' intent that only claims that include the express language “means for” or “step for” be interpreted under 35 U.S.C. §112, paragraph 6. Claims that do not expressly include the phrase “means for” or “step for” are not to be interpreted under 35 U.S.C. §112, paragraph 6.

A portion of the invention of this patent document contains material which is subject to copyright protection. The copyright owner has no objection to the facsimile reproduction by anyone of the patent document or the patent invention, as it appears in the Patent and Trademark Office patent file or records, but otherwise reserves all copyright rights whatsoever.

What claimed is:

1. A composite material comprising (i) a multitude of carbon nanotubes, the majority of the carbon nanotubes having an aspect ratio of at least 25, and arranged substantially parallel to each other, and (ii) a multitude of metal ions capable of forming metallocene bonds between six-member carbon rings comprising carbon nanotube surface, whereby a multitude of metallocene links is formed directly between neighboring carbon nanotubes, adding collectively to the restoring force against carbon nanotube sliding against each other, when said material is subject to tensile strain, whereby said metallocene bonds may break and appear anew at different locations when the value of strain changes.

2. A material of claim 1, wherein the majority of said carbon nanotubes are single wall carbon nanotubes.

3. A material of claim 2, wherein at said ions are chromium ions.

4. A material of claim 1, wherein said ions are chromium ions.

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A composite material comprising
(i) a multitude of carbon nanotubes, the majority of the carbon nanotubes having an aspect ratio of at least 25, and arranged substantially parallel to each other, and having modified surface functionalized with a functional group capable of acting as a hydrogen bond donor, and
(ii) a multitude of carbon nanotubes, the majority of the carbon nanotubes having an aspect ratio of at least 25, and arranged substantially parallel to each other, and having modified surface functionalized with a functional group capable of acting as a hydrogen bond acceptor,
whereby a multitude of hydrogen bonds is formed between said donor groups and said acceptor groups, adding collectively to the restoring force against carbon nanotube sliding against each other, when said material is subject to tensile strain, whereby said hydrogen bonds may break and appear anew between different pairs of functional groups when the value of strain changes.

20. A material of claim 19 wherein the majority of said carbon nanotubes are single wall carbon nanotubes

21. A material of claim 19 wherein the majority of said functional groups are selected from the group consisting of amines, amides, alcohols, ketones, esters, thiols, phenols

22. A material of claim 21 wherein said carbon nanotubes are single wall carbon nanotubes.
